(19) United States
(12) Patent Application Publication
(10) Pub. No.: US 2004/0094904 A1
(43) Pub. Date: May 20, 2004

(54) Low compressive force EMI gasket with perforated substrate and method

(76) Inventor: Tracy Grant, Rochester, NY (US)

Correspondence Address: Stephen B. Salai, Esq., Harter, Secrest & Emery LLP, 1600 Bausch & Lomb Place, Rochester, NY, 14604-2711, US

(21) Appl. No.: 10/294,165

(22) Filed: Nov. 14, 2002

(51) Int. Cl. F16J 15/02

(52) U.S. Cl. 277/628

(57) ABSTRACT

A conductive gasket suitable for electromagnetic interference applications includes a resilient perforated core, preferably of a non-conductive material, that is encapsulated in a non perforated conductive material. The core is preferably is provided with transverse perforation and then is encapsulated in the non perforated conductive material.

### TECHNICAL FIELD

The present invention relates to a conductive gasket for electrical apparatus to block the entry or exit of electromagnetic interference (EMI) and radio frequency interference (RFI) through openings in the apparatus. More particularly, the invention relates to an EMI sealing gasket having improved compression characteristics together with a relatively high surface conductivity.

### BACKGROUND OF THE INVENTION

Many modem electronic devices emit or are sensitive to electromagnetic interference (EMI) at high frequencies. Electromagnetic interference is understood to mean undesired conducted or radiated electrical disturbances from an electric or electronic apparatus, including transients, which can interfere with the operation of other electrical or electronic apparatus. Such disturbances can occur anywhere in the electromagnetic spectrum. Radio frequency interference (RFI) refers to disturbances in the radio frequency portion of the spectrum but often is used interchangeably with electromagnetic interference. Both electromagnetic and radio frequency interference are referred to hereafter as EMI.

Electronic devices, for example, cell phones, computers, various radio frequency and microwave devices, among others, are sources of EMI. These devices not only are sources of EMI, but also the operation of such devices may be adversely affected by the emission of EMI from other sources. Consequently, electric or electronic apparatus susceptible to electromagnetic interference or apparatus likely to generate electromagnetic generally must be shielded in order to operate properly.

The shield generally is any metallic or electrically conductive configuration inserted between a source of EMI and a desired area of protection wherein the shield is capable of absorbing and/or reflecting the EMI. As a practical matter, such shields normally take the form of an electrically conductive housing or cabinet, which is electrically grounded. The shield, in any event, prevents both the radiation of EMI from a source and/or prevents such interference (either generated randomly or by design) from reaching a target within the shielded volume.

A shield comprising a metal cabinet often includes an opening for access to the electronics within the cabinet with a door or other removable cover closing the access opening. Any gap between the confronting, abutting or mating metal surfaces of the cabinet and closure afford an opportunity for the passage of electromagnetic interference. Gaps also interfere with electrical currents running along the surfaces of the cabinets from EMI energy which is absorbed and is being conducted to ground. The gaps reduce the efficiency of the ground conduction path and may even result in the shield becoming a secondary source of EMI leakage from gaps acting as slot antennae. Accordingly, it is common to use a conductive seal or gasket between such surfaces to block the passage of EMI.

Various configurations of gaskets have been developed to close the gaps between components of the shield. These gaskets establish as continuous a conductive path as possible across any gap that may exist, for example, between cabinet components. A common gasket employs a compressible non conductive core enclosed in a conductive material such as a woven fabric made at least in part with conductive fibers. Examples of such fabrics are disclosed in U.S. Pat. No. 4,684,762. Another common gasket construction as disclosed, for example, in U.S. Pat. Nos. 4,857,668, and 5,597,979 has a flexible core enclosed in an electrically conductive sheath formed of a non-conducting woven or non-woven fabric that is rendered conductive by sputter deposition of a conductive metal or by an electroless plating process. After impregnation or coating with silver, the fabric is coated with a non-corrosive material to prevent the oxidation of the silver surface. Suitable coating materials applied either by electroplating or sputter deposition include a pure metal such a nickel or tin, a metal alloy or a carbon compound.

Included among the desirable characteristics of an EMI shielding gasket are ease of compression and a high surface conductivity when disposed between metal surfaces. The ease of compressibility of the gasket allows the gasket to be properly seated between opposing metal surfaces without the application of excessive force to the opposing surfaces. The conductivity of the gasket disposed between opposing surfaces depends, in part, on the degree to which the gasket is compressed during the seating of the gasket. Generally, for example, the higher the compressive force, the more intimate the contact between the gasket and the opposing metal surfaces and the greater the conductivity. However, for ease of assembly, it is desirable that the gasket be seated with as low a compressive force as possible while keeping the surface conductivity of the seated gasket as high as possible.

Accordingly, an object of the present invention is to provide a conductive gasket for EMI applications that provides high surface conductivity relative to the compressive force applied to seat the gasket.

Another object of the invention is to provide a gasket suitable for EMI applications including a nonconductive compressible core encapsulated in a conductive material having enhanced compression and conductivity characteristics.

A further object is to provide a conductive gasket suitable for EMI applications wherein a high surface conductivity of the gasket seated between opposed surfaces is achieved with a minimum of compressive force across the gasket.

Yet another object of the present invention is to provide a method for making an EMI gasket having enhanced compression characteristics while maintaining high surface conductivity.

### SUMMARY OF THE INVENTION

The gasket of the present invention includes a resilient core composed of any suitable material such as non-conductive foam. The core is compressible so when the gasket is disposed between opposed surfaces, forces drawing the opposed surfaces together compress the core so that the core conforms generally to the shape of the opposed surfaces. Encapsulating the core is a conductive material. For purposes of improving the compressibility characteristics of the gasket, the core, prior to its encapsulation, is perforated along its length.

The perforations may extend transversely through the core so as to encompass the obverse and reverse faces of the core. In the alternative, the perforations may extend side-to-side through the core parallel to the obverse and reverse faces or they may be irregular so as to encompass a side of the core and one or both the obverse and reverse faces. Given that the gasket generally is rather thin, it is preferred for ease of manufacture that the core be provided with a plurality of transverse perforations. The through passages created by the removal of a volume of the core material considerably lessen the force required to compress the core. However, the perforations are not so extensive in size and number that the resilience of the core is compromised. In this respect, the size, number and spacing of the sections of the core remaining after perforating are sufficient to provide the core with sufficient structural integrity so the core is not flaccid and will not completely collapse when compressed. For example, when viewed from the perspective of an opposed surface, transverse perforations can remove from 5% to 95% of the surface area of each of the core's obverse and transverse surfaces. Preferably, between about 45% to 55% of the surface area of the core is removed by the perforations.

The conductive material that is applied after perforating the core is not perforated. It is whole and unbroken so it provides the gasket with an unbroken conductive surface. The combination of the non-perforated conductive layer disposed about a perforated core provides the gasket with the surface conductivity of a conventional gasket while substantially decreasing the compressive force required to seat the gasket between opposed surfaces.

Accordingly, the present invention may be characterized in one aspect thereof by a compressible gasket having electromagnetic interference (EMI) properties for disposition between adjacent metal components comprising:

a) a substantially flat core having a plurality of perforations providing passages through the core; and

b) a conductive, non perforated material in intimate contact with the core and encapsulating the core.

In another aspect the present invention may be characterized by a method of forming a gasket having electromagnetic interference (EMI) properties comprising:

a) providing a non perforated core formed of a nonconductive compressible material;

b) perforating the core so as to provide the core with a plurality of through openings; and

c) encapsulating the perforated core with a non-perforated conductive material.

### DESCRIPTION OF THE DRAWINGS

FIG. 1 is a top view of a portion of an EMI gasket according to the present invention with its conductive sheath partly broken away;

FIG. 2 is side elevation view of the gasket partly broken away and in section;

FIG. 3 is a transverse cross sectional view of the gasket;

FIG. 4 is a view similar to FIG. 1 showing another embodiment of the invention; and

FIGS. 5 and 6 are graphs showing test results for gaskets of the controls; and

FIG. 7 is a graph showing test result of a comparable size gasket of the present invention.

### DETAILED DESCRIPTION OF THE INVENTION

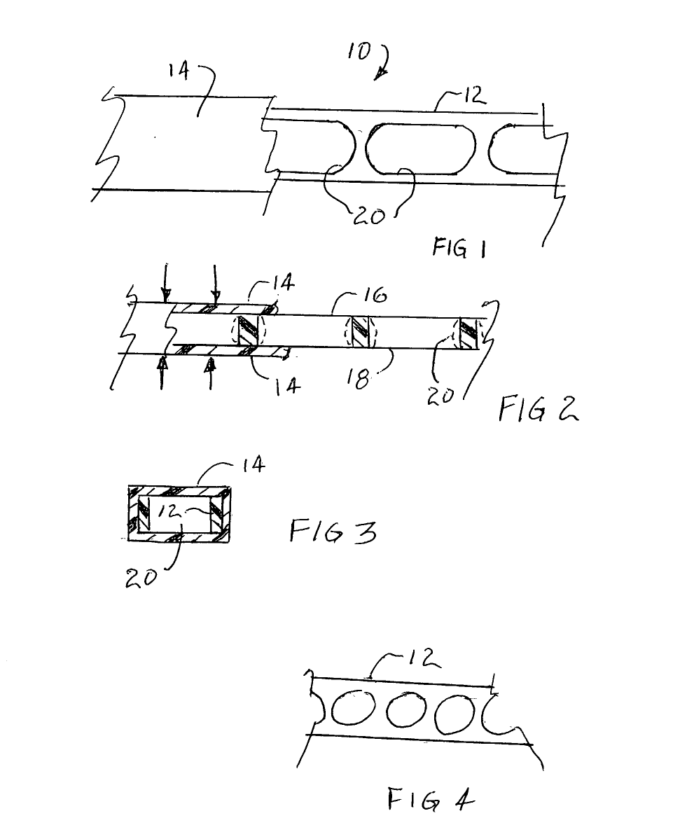

Referring to the drawings, FIG. 1 shows the EMI sealing gasket of the present invention generally indicated at 10 for blocking electromagnetic radiation between at least two opposed electrically conductive bodies (not shown). For example, the gasket could be used to effect an EMI seal between a computer case and a cover for an opening in the case or to seal clearance openings around conductors or connectors.

The gasket comprises a compressible substrate or core 12 that extends the length and width of the gasket and an electrically conductive sheath or surface material 14. The gasket generally is only millimeters thick so in the drawings, the scale is distorted to better illustrate the components. The conductive material is disposed at least on both the obverse and reverse faces 16, 18 of the core (FIG. 2) so the material can bear against and establish electrical contact between opposed conductive bodies pressing against the gasket. Preferably, the conductive material completely surrounds the core as illustrated in FIG. 3.

The core is composed of a material that is resilient and compliant. This will allow the gasket to conform closely to the surface contours of opposed bodies when subjected to a compressive force drawing the opposed bodies together and against the opposite faces of the gasket. The core can be formed of either a conductive or non-conductive material. However a non-conductive material is preferred as such materials generally are less expensive. The core may be composed felt, knitted fabrics, mineral fiber mats or other compressible material. For purposes of the present invention a rubber or polymer that can be cut or molded is preferred such as foamed polyurethane or the like. A typical core could be a foam material of a density as required for the particular application.

The electrically conductive sheath or surface material 14 can comprise various forms of woven or non-woven conductive material that is flexible enough to wrap around the core and to conform to the surface contour of the opposed conductive bodies pressing against the conductive material 14. For example, the material can be a cured polymer incorporating metal fibers or a fabric or thin batt incorporating metal fibers or filaments to render the material conductive. The material 14 also can be a non-conductive fabric wherein a metal plating or a vapor deposited metal coating renders the material conductive. As shown in the figures, the conductive sheath 14 preferably is wrapped around or other wise encapsulates the core 12. When wrapped around the core opposite ends of the sheath (not shown) can be butted one against the other or over lapped to avoid a break or discontinuity in the conductive surfaces of the gasket.

In accordance with the present invention, the core 12 is provided with a plurality of transverse passages 20 that extend through the core. The passages are equally spaced along the length of the core and can take various shapes. The cross section of the passages as viewed in the plane of the gasket or plan view can have either a regular or irregular shape. It is preferred that the cross section be regular such as elongated ovals as shown in FIGS. 2 and 3 or circular as shown in FIG. 4. The number and size of the passages 20 formed through the core 12 operate to increase the compressibility of the core. In this respect a lower compressive force is required to compress a core having the passages than to compress a similar size core that is solid and does not have the passages.

As shown in the figures, the number, size and extent of the perforations are not so extensive that the core is completely hollowed out. The sections 22 of the core that remain between the passages 20 and that are located at spaced intervals along the core prevent the core from being flaccid and completely collapsing when compressed between opposed bodies. Thus, enough of the core remains to fully support the conductive material 14. A balance between rendering the core more compressible while maintaining support for the conductive material for purposes of the present invention is achieved if between 5% and 95% and preferably between 45% and 55% of the surface area of the gasket is removed by the perforations.

The through passages reduce the mass of the core so a lower force is required to achieve a measured compression of the core. In addition, as a force is applied to transversely compress the core, the core flattens. The flattening of the core is manifested by the lengthwise and widthwise expansion. This expansion along the length and width of the core is accommodated in part by the through passages 20. In this respect, and as shown in dotted lie in FIG. 2, the sections 22 of the core adjacent the passages 20 deform and expand into the passages as the core is compressed. The room for this expansion provided by the passages along the length of the core also enhances the compressibility of the core.

In contrast to the core 12 and as shown in FIGS. 1-3, the sheath 14 is not perforated. It is whole and unbroken and extends across the openings of the passages 20 through the core. The net effect of having a sheath 14 that is not perforated is that the conductive surface it presets to the opposing conductive bodies is unbroken so there are no discontinuities that may compromise the conductivity of the gasket surface. Thus the contact resistance of the gasket when disposed between opposed conductive bodies remains relatively low and the conductivity relatively high.

Accordingly, for purposes of manufacturing the gasket of the present invention, the core 12 first is formed with the through passages 20. Casting or molding can do this so the passages are created with the forming of the core. However, it is preferred that the core is formed as a solid piece and then after formation, the core is perforated to form the through passages. After the core is formed with the through passages 20, the non-perforated conductive material 14 is applied to at least the opposite faces 16, 18 of the core. Preferably the conductive material 14 is wrapped or otherwise disposed about the core so as to encapsulate the core. In this fashion the gasket 10 of the present invention is produced with a conductive material 14 forming a non-perforated and unbroken conductive layer over at least the opposite faces of a core having a plurality of spaced through passages 20.

Various tests were conducted to compare the compressibility and surface conductivity of the gasket of the present invention against other gasket configurations. One gasket was a control comprising a gasket of conventional design having a solid core surrounded by a non-perforated conductive fabric. A second gasket was a conventional gasket, which had been perforated after assembly so the through passages were formed through both the encapsulating conductive fabric and the core. The gaskets in all cases were formed of similar core and conductive materials and were of the same size.

The gaskets used for the tests each had a core that was about 0.236 inches (6 mm) wide formed of the same conventional Emi gasket core material. The conductive fabric in each case was Nickel-Copper plated polyester wrapped about the core so as to be in intimate contact with the four faces of the core. During the course of the tests the gaskets of each design was subjected to a compressive force. At various levels of compression, the force need to achieve the compression was recorded. Also at each level of compression, the contact resistance of the gasket surface was measured. Contact resistance is a measure of the surface conductivity of the gasket at the various stages of compression. In general, contact resistance decreases (and surface conductivity increases) as the compressive force increases. For purposes of the present invention, it is desirable to have a gasket that provides a high surface conductivity when a low compressive force is used to seat the gasket.

In the following tests, Sample “A” represents a gasket according to the present invention wherein only the core is perforated. In this case the 0.236 inch (6 mm) wide foam core of the gasket was first transversely perforated with 0.150 inch (3.8 mm) diameter passages through the core spaced about 0.222 inches (5.6 mm) apart, center to center, along the length of the core. Perforating in this manner removed about 33% of the surface area of the obverse and reverse surfaces of the core. After perforating, the core was wrapped with the conductive Nickel-Copper plated polyester sheath material to form a substantially unbroken non-perforated surface over the openings to the perforations.

Sample “B” was a gasket of similar construction except that the perforations were formed after assembly, that is after wrapping the core with the conductive polyester sheath material so that the passages formed by the perforating step passed through both the sheath material and core.

Sample C was a control comprising a gasket of similar construction but of a conventional design wherein neither the core nor the conductive sheath were perforated so the core is encapsulated in a substantially unbroken, non-perforated conductive fabric.

The measurement of the contact resistance is generally in accordance with the test procedures as set out in ASTM #D991, ASTM #B539 and Mil-G-83528A. Briefly, in these tests the test specimen is placed on a height adjustable platform and between two parallel contact plates. The platform is raised to compress the test specimen between the two plates until a load of 0.02 kg registers on a force gauge. The platform then is raised in increments of 10% of the sample height until the sample is under 70% compression. At each stage of compression the load is measured to the nearest 0.02 kg and the resistance across the gasket is measured to the nearest 0.001 ohms. Calculations then are made to determine the percent compression on the seal and the contact resistance at each load reading.

The percent compression (C) is computed according to the formula

C=D/H*100

where

D=the deflection of the seal in inches and

H=height of the sample in inches.

The contact resistance (Cᵣ) is computed according to the formula

Cᵣ=R*S

wnere

R=the resistance reading at each stage of compression and

S=the sample length in inches

The test results are reported in Table I below and are illustrated graphically in FIGS. 5-6.

In Table I, the level of compression is expressed as a percent of decrease from the original thickness of the gasket. The force required to compress the gasket is expressed as the compressive load deflection or CLD as measured in kilograms per inch of deflection. The resistance at each of the stages of compression is measured and the value for the contact resistance is calculated as noted above and the results expressed in ohm-inches.

TABLE I

| | Compression | CLD | Contact Resistance |
|---|---|---|---|
| | (%) | (kg/in) | (ohm*inches) |
| Sample A* | 10 | 0.57 | 0.0064 |
| Sample B** | 10 | 0.16 | 0.0380 |
| Sample C*** | 10 | 0.42 | 0.0088 |
| Sample A | 20 | 0.69 | 0.0062 |
| Sample B | 20 | 0.34 | 0.0170 |
| Sample C | 20 | 0.66 | 0.0064 |
| Sample A | 30 | 0.71 | 0.0062 |
| Sample B | 30 | 0.49 | 0.0110 |
| Sample C | 30 | 0.81 | 0.0064 |
| Sample A | 40 | 0.78 | 0.0060 |
| Sample B | 40 | 0.64 | 0.0086 |
| Sample C | 40 | 0.98 | 0.0058 |
| Sample A | 50 | 1.04 | 0.0054 |
| Sample B | 50 | 0.85 | 0.0072 |
| Sample C | 50 | 1.39 | 0.0050 |
| Sample A | 60 | 1.48 | 0.0048 |
| Sample B | 60 | 1.47 | 0.0060 |
| Sample C | 60 | 2.02 | 0.0044 |
| Sample A | 70 | 2.53 | 0.0042 |
| Sample B | 70 | 2.83 | 0.0048 |
| Sample C | 70 | 4.03 | 0.0038 |

*Perforated Core
**Perforated After Assembly
***Non-perforated Conventional Gasket

Reference to Table I shows that of the three samples, the control, Sample “C” which is the conventional gasket, has generally a lower contact resistance (better surface conductivity) over the entire compressive range. Sample “B”, which represents a gasket perforated after assembly, is easier to compress than the control (as measured by the CLD) but has a higher (and poorer) contact resistance over the compression range. The higher contact resistance, and therefore lower surface conductivity, can be attributed to the reduction in the surface area of the conductive material brought about by perforating the conductive material.

The inventive gasket, Sample “A”, having a perforated core and a non perforated sheath ha a contact resistance that is only slightly higher, but comparable to the contact resistance of the control (Sample C) and therefore much better than that of the perforated gasket, Sample “B”. However, the compressibility of the inventive gasket is significantly improved relative to the control over all degrees of compression above 20%. Accordingly, the inventive gasket achieves a significant improvement in compressibility with little reduction in surface conductivity (due to slightly higher contact resistance). While the perforated gasket of Sample “B” is more compressible than either the control (Sample “C”) or the inventive gasket (Sample “A”), the better compressibility is not acceptable in view of the reduction in surface conductivity. The gasket of the present invention, however, provides better compressibility with little or no loss in surface conductivity.

It also is to be noted that as the compression of the gasket increases, there is an improvement in gasket performance as evidenced by the compression ratio of the inventive Sample “A” and the perforated gasket, Sample “B”. In this respect the ratio of CLD for Sample A versus Sample B at 30% compression is 1.45 and at 70% compression the ratio is 0.89.

It has been found that simply providing voids in the structure of the gasket core, such as by increasing the cell size of a foamed core, does not provide comparable results to perforating the core. This is because increasing cell size (and lowering foam density) detracts from the ability to control and maintain the shape of the gasket. Perforating as described herein allows better control of the shape and compressive properties of the gasket.

While the preferred embodiment is described in the context of having the core transversely perforated, it should be appreciated that the perforations could extend from side-to-side through the core. Also the perforations need not be uniformly spaced along the gasket and the shape can be other than round such as oval or irregularly shaped.

Accordingly, it should be appreciated that the present invention accomplishes its intended objects in providing an EMI gasket that has better compressibility than a conventional gasket with little or no compromise of the surface conductivity of the gasket.

Having described the invention in detail, what is claimed as new is:

1. A compressible gasket having electromagnetic interference (EMI) properties for sealing between opposed conductive bodies comprising:
a) a substantially flat core having a plurality of perforations providing passages through the core; and
b) a conductive, non perforated material in intimate contact with the core and encapsulating the core.

2. A gasket as in claim 1 wherein the passages extend transversely through the core and are at spaced intervals along the length of the core.

3. A gasket as in claim 2 wherein the perforations are regular in cross section and are equally spaced along the length of the core.

4. A gasket as in claim 2 wherein the perforations are circular or oval in cross section.

5. A compressible gasket having electromagnetic interference (EMI) properties for sealing between opposed conductive bodies comprising:
a) a substantially flat core having obverse and reverse faces, the core formed of a resilient and compliant compressible material and having a plurality of transverse passages extending through the core wherein opposite ends of each passage form openings in the obverse and reverse faces respectively; and
b) a conductive, non perforated material in intimate contact with the obverse and reverse surfaces of the core and encapsulating the core, the material presenting substantially continuous and unbroken surfaces for disposition against the opposed conductive bodies.

6. A gasket as in claim 5 wherein the openings are spaced along the length of the gasket.

7. A gasket as in claim 5 wherein the openings in each of the obverse and reverse faces comprise 5% to 95% of the surface area of each of the obverse and reverse faces.

8. A gasket as in claim 5 wherein the openings are circular.

9. A gasket as in claim 5 wherein the openings are elongated ovals.

10. A gasket as in claim 5 wherein the core is composed of nonconductive foam.

11. A gasket as in claim 6 wherein the core is composed of foamed polyurethane.

12. A method of forming a gasket having electromagnetic interference (EMI) properties comprising:
a) forming a core of a nonconductive compressible material with a plurality of transverse passages that open through obverse and reverse faces of the core; and
b) encapsulating the perforated core with a non-perforated conductive material.

13. A method as in claim 12 comprising forming the core as a solid body and then perforating the core to provide the through passages.

14. A method as in claim 13 comprising perforating to provide the core with a plurality of spaced circular through passages.

15. A method as in claim 14 wherein the perforations are equally spaced along the length of the core

16. A method as in claim 13 comprising perforating to provide the core with a plurality of spaced elongated oval passages.

17. A method as in claim 16 wherein the perforations are equally spaced along the length of the core.

18. A method of forming a gasket having electromagnetic interference (EMI) properties comprising:
a) providing a non perforated core formed of a nonconductive compressible material;
b) perforating the core so as to provide the core with a plurality of through openings; and
c) encapsulating the perforated core with a non-perforate conductive material.

19. A method as in claim 18 wherein said perforating provides substantially equally spaced transverse passages through the core that are generally circular in cross section.

20. A method as in claim 18 wherein said perforating provides substantially equally spaced transverse passages through the core that are generally oval in cross section.
